(19) United States
(12) Patent Application Publication
(10) Pub. No.: US 2008/0268877 A1
(43) Pub. Date: Oct. 30, 2008

(54) METHOD AND APPARATUS FOR EXCHANGING SIGNALING A WIRELESS COMMUNICATION SYSTEM

(75) Inventor: John M. Harris, Glenview, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/739,299

(22) Filed: Apr. 24, 2007

(51) Int. Cl. H04Q 7/20

(52) U.S. Cl. 455/458

(57) ABSTRACT

A communication system provides for an expedited access attempt by a mobile station, wherein the mobile station attempts to access an access network despite unsuccessfully decoding an overhead message such as a paging message. The mobile station decodes a first overhead message, such as a quick page message, comprising one or more indicators, wherein each indicator is associated with a mobile station being paged. When the mobile station determines, based on the one or more indicators, that the mobile station is an intended target of the first overhead message, the mobile station attempts to decode a second overhead message, such as a paging message, comprising another one or more indicators associated with the mobile stations being paged and, in response to unsuccessfully decoding the second overhead message, conveys a response to the second overhead message to the access network without waiting for a successful decoding of an additional overhead message.

### FIELD OF THE INVENTION

The present invention relates generally to signaling in wireless communication systems, and, in particular, to pages and page responses in a wireless communication system.

### BACKGROUND OF THE INVENTION

When a network receives a call, a Short Message Service (SMS) message, or packet intended for a mobile station (MS) serviced by the network, the network will typically page the MS. In order to conserve battery life, the paging process has been divided into two steps. In a first step, the mobile stations (MSs) serviced by the network monitor a quick page channel, for example, a QCH (Quick Page Channel) or a PICH (Paging Indicator Channel). The MSs know when QuickPage messages are broadcast on the quick page channel and wake up only to receive and decode the QuickPages messages. An MS then determines that it is likely a paging target by matching an identifier included in the QuickPage message with an identifier maintained by the MS. In the second step, in response to determining that it is a paging target, the MS monitors a paging channel, such as a PCH (Paging Channel) and wakes up to receive and decode a paging message.

The QuickPage messages are shorter than a paging message and consume less energy to receive and decode. Thus, when an MS periodically wakes up to receive and decode QuickPage messages instead of periodically waking up to receive and decode paging messages, battery life is conserved. The MS then only wakes up to receive a paging message when the MS guesses, correctly or incorrectly and based on the QuickPage message, that it is an intended target of the paging message.

When an MS successfully decodes a paging message, that is, if the identifier maintained by the MS matches the information within the page message, the MS will then attempt to access the network. In some systems, this access is known as a page response. When the MS is unable to successfully decode the paging message, the MS will then go back to sleep and wake up during a next paging cycle to receive and decode a next quick page or paging message, repeating this process until the MS successfully decodes the paging message and successfully responds or until the network or MS gives up all together. Repaging an MS that is an intended target of an unsuccessfully decoded paging message consumes valuable system capacity and introduces delay into system access and call set up, and MSs that repeatedly wake up to receive and decode paging message after paging message consume an excessive amount of battery life.

Therefore a need exists for a method and an apparatus for paging an MS that preserves system capacity, reduces access delay, and preserves battery life.

### BRIEF DESCRIPTION OF THE DRAWINGS

FIG. 1 is a block diagram of a wireless communication system in accordance with an embodiment of the present invention.

FIG. 2 is a logic flow diagram of a method of responding to an overhead message by a mobile station of FIG. 1 in accordance with an embodiment of the present invention.

FIG. 3 is a block diagram of an exemplary quick page message in accordance with an embodiment of the present invention.

One of ordinary skill in the art will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION OF THE INVENTION

To address the need for a method and an apparatus for paging a mobile station that preserves system capacity, reduces access delay, and preserves battery life, a communication system provides for an expedited access attempt by a mobile station, wherein the mobile station attempts to access an access network despite unsuccessfully decoding an overhead message such as a paging message. The mobile station decodes a first overhead message, such as a quick page message, comprising one or more indicators, wherein each indicator is associated with a mobile station being paged. When the mobile station determines, based on the one or more indicators, that the mobile station is an intended target of the first overhead message, the mobile station attempts to decode a second overhead message, such as a paging message, comprising another one or more indicators associated with the mobile stations being paged and, in response to unsuccessfully decoding the second overhead message, conveys a response to the second overhead message to the access network without waiting for a successful decoding of an additional overhead message.

Generally, an embodiment of the present invention encompasses a method for exchanging signaling in a wireless communication system. The method includes decoding, by a mobile station, a first overhead message comprising one or more indicators, wherein each indicator of the one or more indicators is associated with an mobile station being paged and determining, based on the one or more indicators, whether the mobile station is an intended target of the first overhead message. The method further includes, in response to determining that the mobile station is an intended target of the first overhead message, attempting to decode a second overhead message comprising another one or more indicators associated with the mobile stations being paged and, in response to unsuccessfully decoding the second overhead message, conveying a response to the second overhead message to an access network without waiting for a successful decoding of an additional overhead message.

Another embodiment of the present invention encompasses a mobile station that is configured to respond to signaling in a wireless communication system by decoding a first overhead message comprising one or more indicators, wherein each indicator of the one or more indicators is associated with a mobile station being paged, determining, based on the one or more indicators, whether the mobile station is an intended target of the first overhead message, in response to determining that the mobile station is an intended target of the first overhead message, attempting to decode a second overhead message comprising another one or more indicators associated with the mobile stations being paged, and in response to unsuccessfully decoding the second overhead message, conveying a response to the second overhead message to an access network without waiting for a successful decoding of an additional overhead message.

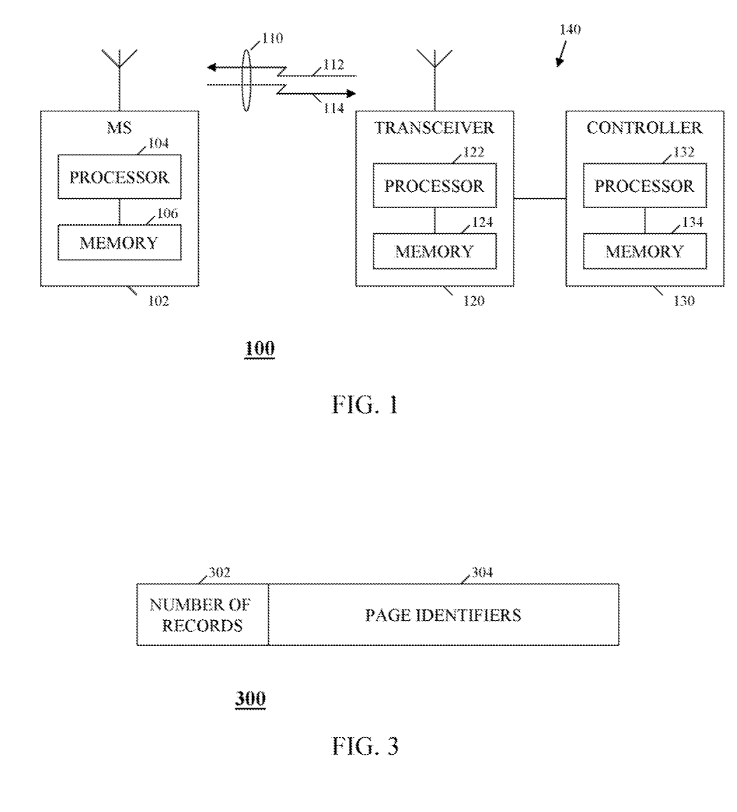

The present invention may be more fully described with reference to FIGS. 1-3. FIG. 1 is a block diagram of a wireless communication system 100 in accordance with an embodiment of the present invention. Communication system 100 includes a wireless access network 140, such as a Radio Access Network (RAN) or a Base Station (BS). Access network 140 includes at least one transceiver 120, such as a Base Transceiver Station (BTS) or a Node B, that is operably coupled to a controller 130, such as a Base Station Controller (BSC) or a Radio Network Controller (RNC).

Access network 140 provides wireless communication services to mobile stations, such as mobile station (MS) 102, located in a coverage area, such as a sector or a cell, of the access network via an air interface 110. MS 102 may be any wireless communication device capable of wirelessly communicating with a wireless infrastructure, such as but not limited to a cellular phone, a radiotelephone, a smart phone, or a wireless communication-enabled personal computer, laptop computer, or personal digital assistant (PDA). In various wireless communication technologies, MS 102 also may be referred to as a user equipment (UE), an access terminal (AT), or a subscriber unit (SU). Air interface 110 includes a forward link 112 having multiple forward link signaling channels, including various common signaling channels such as a paging channel, for example, a PCH (Paging Channel), and a quick page channel, for example, a QPC (Quick page Channel) or a PICH (Paging Indicator Channel), and multiple forward link traffic channels. Air interface 110 further includes a reverse link 114 having multiple reverse link channels, including multiple reverse link signaling channels, one or more access channels, and multiple reverse link traffic channels.

Each of MS 102, transceiver 120, and controller 130 includes a respective processor 104, 122, 132, such as one or more microprocessors, microcontrollers, digital signal processors (DSPs), combinations thereof or such other devices known to those having ordinary skill in the art. The particular operations/functions of processors 104, 122, and 132, and respectively thus of MS 102, transceiver 120, and controller 130, are determined by an execution of software instructions and routines that are stored in a respective at least one memory device 106, 124, 134 associated with the processor, such as random access memory (RAM), dynamic random access memory (DRAM), and/or read only memory (ROM) or equivalents thereof, that store data and programs that may be executed by the corresponding processor. Unless otherwise specified herein, the functions performed by each of MS 102, transceiver 120, and controller 130 are performed by the respective processor 104, 122, and 132 of the MS, transceiver, and controller.

The at least one memory device 106 of MS 102 further includes an identifier that uniquely identifies MS 102 in communication system 100. This identifier may be programmed into MS 102 or obtained by the MS from communication system 100. When communication system 100 broadcasts overhead messages, as described below, that are intended for MS 102, the overhead messages include at least a portion of this identifier. For example, when paging the MS, access network 140 may be conveyed the MS's identifier by a gateway, such as a Mobile Switching Center (MSC), that has downloaded the profile of the MS from a system profile database, such as a Home Location Register (HLR), Visited Location Register (VLR), or Home Subscriber Server (HSS). By way of another example, in response to receiving a communication from MS 102, for example, when MS 102 registers with communication system 100, access network 140 may obtain the MS's identifier from the communication or from a profile of the MS maintained in the system profile database.

In order for MS 102 to establish a connection with access network 140, communication system 100 operates in accordance with well-known wireless telecommunications standards. Preferably, communication system 100 is an Ultra Mobile Broadband (UMB) or Code Division Multiple Access (CDMA) 2000 communication system that operates in accordance with the 3GPP2 (Third Generation Partnership Project 2) standards. The 3GPP2 standards specify wireless telecommunications system operating protocols, including radio system parameters, call processing procedures, and the like. However, those who are of ordinary skill in the art realize that communication system 100 may operate in accordance with any one of a variety of wireless communication standards, such as but not limited to a Global System for Mobile Communications (GSM) system, later generations of the GSM standard, such as General Packet Radio Service (GPRS), Enhanced Data for Global Evolution (EDGE), and Universal Mobile Telecommunication Service (UMTS), Long-Term Evolution (LTE) a Time Division Multiple Access (TDMA) communication system, a Frequency Division Multiple Access (FDMA) communication system, Wireless Local Area Network (WLAN) communication system as described by the IEEE (Institute of Electrical and Electronics Engineers) 802.xx standards, for example, the 802.11, 802.15, 802.16 (including .16e, .16j, and .16m), or 802.20 standards, or Fourth Generation (4G) communication systems such as an Orthogonal Frequency Division Multiple Access (OFDM) communication system.

The embodiments of the present invention preferably are implemented within MS 102 and access network 140, and more particularly with or in software programs and instructions stored in the respective at least one memory device 106, 124 of MS 102 and transceiver 120 and executed by the respective processors 104 and 122. However, one of ordinary skill in the art realizes that the embodiments of the present invention alternatively may be implemented in hardware, for example, integrated circuits (ICs), application specific integrated circuits (ASICs), and the like, such as ASICs implemented in one or more of the MS 102 and transceiver 120. Based on the present disclosure, one skilled in the art will be readily capable of producing and implementing such software and/or hardware without undo experimentation.

In the prior art, when a network receives a call or a Short Message Service (SMS) message intended for an MS serviced by the network, the network will page the MS by including an indicator, or identifier, associated the MS in both a quick page message and in each of one or more subsequent paging messages. The MS then attempts to access the network only after successfully decoding both the quick page message and a subsequent paging message, and will continue to receive and decode paging messages until a paging message matching is successfully decoded. In order to provide for an expedited access to access network 140, communication system 100 provides for an MS, such as MS 102, to attempt to access a network after successfully decoding a quick page message and unsuccessfully decoding a subsequent paging message, without waiting for a successful decoding of a paging message.

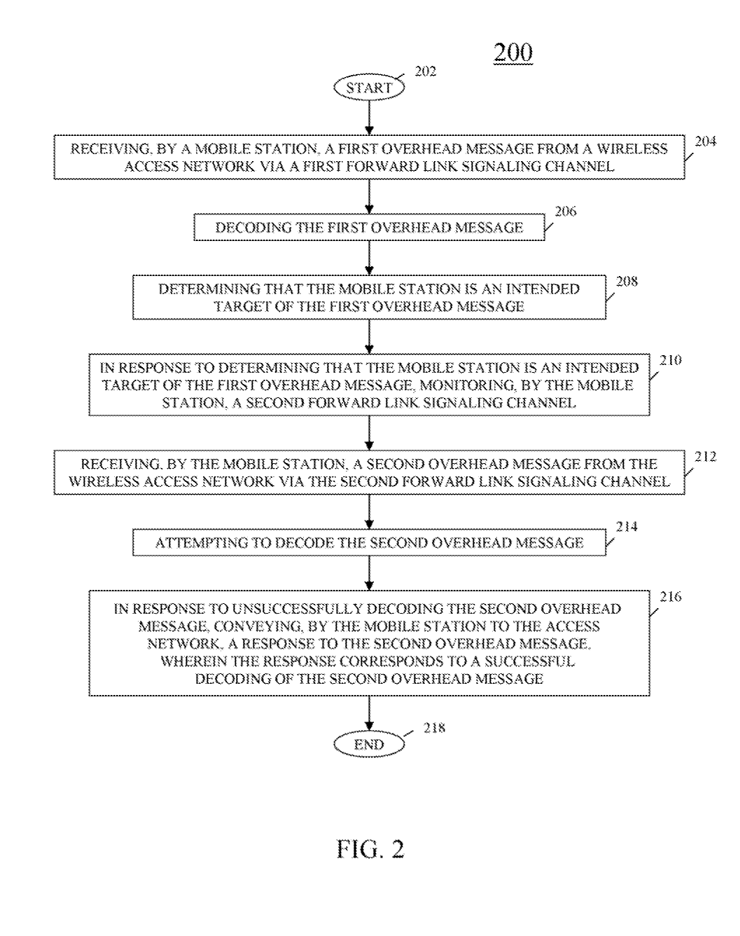

Referring now to FIG. 2, a logic flow diagram 200 is provided that illustrates a method of responding to an overhead message, such as a paging message, by an MS, such as MS 102, in accordance with an embodiment of the present invention. Logic flow diagram 200 begins (202) when communication system 100 determines to page an MS, such as MS 102. For example, communication system 100 may have received a call or a Short Message Service (SMS) message intended for MS 102 or the communication system may desire that MS 102 report to the access network for any one or a variety of operational purposes, such as a location update or to provide, to the MS, an updated presence attribute. In response to the determination to page MS 102, access network 140, and in particular transceiver 120, broadcasts, and the MS receives (204) from the access network, a first overhead message, preferably a quick page message such as a QuickPage message, via a first forward link signaling channel, preferably a Quick Page Channel (QPC) or a Paging Indicator Channel (PICH).

The first overhead message includes one or more indicators associated with each MS that is a target of the message. Each indicator typically comprises an identifier associated with an MS that is an intended target of the message and is intended to alert each indicated, or identified, MS that the MS should monitor a second forward link signaling channel, preferably a paging channel, for a second, longer duration overhead message. For example, when a forward link, such as forward link 112, of a communication system, such as communication system 100, includes a quick page channel, such as a QPC or PICH, and further includes a paging channel, such as a PCH (Paging Channel), an overhead message conveyed on the quick page channel may indicate that an MS identified in the overhead message should monitor the paging channel. By periodically broadcasting the first overhead message instead of the second overhead message, communication system 100 permits each MS serviced by the communication system to wake up for a shorter period of time to determine if the MS is being paged than the MS would have to wake up for if the MS had to periodically receive and decode a the second overhead message, thereby preserving the energy of a limited life power source, such as a battery, providing power to the MS.

For example, FIG. 3 is a block diagram of an exemplary QuickPage message 300 in accordance with an embodiment of the present invention. QuickPage messages are well known in the art and will not be described in detail herein except to note that they typically include a first data field 302 (or header) that typically comprises two or three bits and that indicates a number of records or a range of the number of records, that is, mobile stations (MSs), that are being paged, and a second data field 304 that typically comprises 32 or 33 bits and that includes an indicator of each MS being paged. Typically, when multiple MSs are being paged, each indicator included in second data field 304 may comprise only a portion of a full MS identifier. For example, when only one MS is being paged, second data field 304 may include a full 32 bit identifier associated with the MS, whereas when two MSs are being paged, second data field 304 may include the 16 least significant bits of each MS's identifier, when three MSs are being paged, second data field 304 may include either the 10 or 11 least significant bits of each MS's identifier, when four MSs are being paged, second data field 304 may include the 8 least significant bits of each MS's identifier, and when five to nine MSs are being paged, second data field 304 may turn on three specific bit positions which correspond to that MS's identifier. By including only a portion of each MS's identifier in the first overhead message when multiple MSs are being paged, the length of the first overhead message is reduced and a period of time during which the MS has to wake up, receive, and decode the first overhead message also is reduced, thereby preserving the energy of a limited life power source of the MS. Additionally, if more than five are paged then the MS may count the number of bits turned on to approximate the number of identifiers or MSs which are being signaled through the quick paging message. In systems where the first field is omitted, this method would be used to determine the number of records or the approximate number of MSs which are being signaled through the QPC.

In another embodiment of the present invention, when multiple MSs (typically five or more) are being paged, the indicator included in second data field 304 of QuickPage message 300 may not convey a particular portion of the MS's identifier. Instead, a predetermined equation maintained in the at least one memory device 106 of each MS may be executed by the MS to determine three specific bit positions, among the 32 or 33 possible bit positions in second data field 304, which are associated with that MS. If the MS is paged, communication system 100 will set all of those bit positions to ‘1’. If the MS sees that all of those bit positions are set to ‘1’, then the MS will monitor for a paging message. In this case, the first overhead message conveys an indicator of the MS but not, specifically, the MS's identifier—as many other MSs will also hash to the same three bit positions as that MS.

Referring again to FIG. 2, in response to receiving the first overhead message, MS 102 decodes (206) the first overhead message in order to determine whether the MS is an intended target of the first overhead message, that is, whether the MS is being paged. More particularly, MS 102 decodes the received first overhead message and determines whether the message includes an indicator that comprises at least a portion of an identifier associated with the MS. For example, when MS 102 decodes the one more indicators included in the first overhead message, the MS then determines whether any of the decoded indicators matches an identifier maintained in the at least one memory device 106 of the MS. As each indicator included in the first overhead message may comprise only a portion of a full identifier, MS 102 may determine whether the decoded indicator matches a corresponding portion of the identifier maintained by the MS.

In response to determining (208), by MS 102, that the MS is an intended target of the first overhead message, that is, when there is a match, MS 102 then monitors (210) the second forward link signaling channel. The second forward link signaling channel may or may not be the same as the first forward link signaling channel. Access network 140, and in particular transceiver 120, then broadcasts, and MS 102 receives (212), a second overhead message, preferably a paging message, over the second forward link signaling channel. The second overhead message includes an indicator comprising a full identifier associated with each MS identified in the first overhead message and may further include other paging related information as is known in the art. However, in another embodiment of the present invention, the second overhead message may indicate a portion (typically a longer portion), or an additional portion of the identifier associated with each such MS. Thus the second overhead message confirms each indication in the first overhead message that an MS is a target of a page.

In response to receiving the second overhead message, MS 102 attempts (214) to decode the second overhead message and confirm that it is being paged by access network 140. When MS 102 unsuccessfully decodes the second overhead message, for example, when the second overhead message is an erased paging message, the MS nevertheless conveys (216), to access network 104, a response, such as an access sequence and bind request or a Page Response message, to the second overhead message without waiting for an additional overhead message, such as another paging message, wherein the response corresponds to a successful decoding second overhead message. Logic flow 200 then ends (218).

In one embodiment of the present invention, in order to minimize a likelihood that the MS is improperly responding, that is, responding to an unsuccessfully decoded second overhead message when the MS is not an intended target of the first or second overhead messages, MS 102 may determine whether to convey a response to the second overhead message without waiting for an additional overhead message based on a quantity of MS identifiers in the first overhead message. That is, as is known in the art, a paging of a large number of MSs via a QuickPage message results in a higher false positive rate, that is, a larger number of MSs that erroneously determine that they are targets of the QuickPage message. Allowing an MS to attempt to access a network when the MS has failed to successfully decode a paging message may result in a deluge of access attempts by MSs that have erroneously decoded the QuickPage message and determined that the network may be trying to page them. By providing for an expedited paging response when the number of MSs indicated in the first overhead message, for example, a QuickPage message, is less than a threshold, communication system 100 better assures that each MS that determines that is a target of the first overhead message does so correctly, increasingly the likelihood that access network 140 intends to page the MS despite an unsuccessful decoding of the second overhead message. Additionally, by only responding if the second overhead message is not decoded successfully, the potential deluge of access attempts by mobiles is further reduced. This is because only a small subset of the mobile stations within a sector or cell will fail to decode the paging message successfully. In this way, the paging message reliability is effectively increased.

As a result, in one such embodiment of the present invention, MS 102 may compare the quantity of MS identifiers in the first overhead message to a threshold maintained in the at least one memory device 106 of the MS. When the quantity is less than the threshold, then the MS may determine to convey a response to the second overhead message despite an unsuccessful decoding. In another such embodiment of the present invention, MS 102 may compare the quantity of MS identifiers in the first overhead message to a quantity range maintained in the at least one memory device 106 of the MS. When the quantity of MS identifiers in the first overhead message is within the given range of quantities, then the MS may determine to convey a response to the second overhead message despite an unsuccessful decoding.

In other embodiments of the present invention, MS 102 may determine whether to convey a response to the second overhead message without waiting for an additional overhead message based on a power level of a power source of the MS, for example, based on a battery level of the MS or based on whether the MS is connected to a power outlet. In this way, MS 102 may expend the energy for a possible improper response when the MS has adequate power remaining in the battery and may avoid a possible improper, power consuming, response when the MS's battery power level is low.

In still other embodiments of the present invention, MS 102 may determine to convey a response to the second overhead message without waiting for an additional overhead message based on a quantity of time remaining until the MS is likely to otherwise convey a message to access network 140. When the MS is likely to be communicating soon with the access network, for example, is likely to be communicating with the access network within a period of time that is less than a time threshold maintained in the at least one memory device 106 of the MS, then the MS may decide not to convey a response to the second overhead message without waiting for an additional overhead message since the MS soon will be communicating with the access network anyways. For example, MS 102 may determine to convey a response to the second overhead message without waiting for an additional overhead message based on one or more of a time remaining until a next presence update by MS 102, a time remaining until a next email synchronization by MS 102, a distance from MS 102 to a next routing area, and a time remaining until a next routing area update is to be provided by MS 102.

In yet other embodiments of the present invention, MS 102 may determine to convey a response to the second overhead message without waiting for an additional overhead message based on a possibility that another MS may attempt to contact MS 102 or based on a knowledge that a data update or a collection of data is available for conveyance to access network 140. For example, MS 102 may determine to convey a response to the second overhead message without waiting for an additional overhead message based on knowledge that a presence attribute of a presentity associated with the MS has changed but that the change has not yet been conveyed to the access network, based on a state of a presence attribute associated with a presentity corresponding to a user of MS 102, based on a state of a presence attribute associated with a presentity corresponding to a user of a buddy MS, for example, when the buddy is activated or when a state of a presence attribute of the buddy indicates that the buddy may be likely to initiate a call, based on a presence of one or more emails in an outbox of MS 102 that have not yet been conveyed to the access network, and/or based on a quantity of emails in an outbox of MS 102 that have not yet been conveyed to the access network.

In still another embodiment of the present invention, MS 102 may determine to convey a response to the second overhead message without waiting for an additional overhead message based on a quantity of previous quick page messages that comprised an indicator that matched an indicator associated with the MS, for example, conveying the response when the quantity exceeds a quantity threshold maintained by the at least one memory device 106 of the MS. In yet another embodiment of the present invention, MS 102 may determine to convey a response to the second overhead message without waiting for an additional overhead message based on a paging interval, such as a quick page or a paging message interval, known to the MS. For example, when the paging interval exceeds a paging interval threshold maintained by the at least one memory device 106 of the MS 102, then the MS may convey the response to the second overhead message, and when paging interval is less than the paging interval threshold, then MS 102 may wait to receive and decode another page before determining whether the MS may properly respond.

By providing for MS 102 to attempt an access of access network 140 despite unsuccessfully decoding a second overhead message comprising another one or more indicators associated with the MSs being paged and without waiting for another overhead message, communication system 100 expedites the access attempt by the MS. Prior to receiving and decoding the second overhead message, MS 102 decodes a first overhead message that includes one or more indicators, wherein each indicator of the one or more indicators is associated with an MS being paged. Based on the one or more indicators in the first overhead message, MS 102 determines that it is an intended target of the first overhead message and, based on the determination, attempts to decode the second overhead message. Despite unsuccessfully decoding the second overhead message, MS 102 nevertheless conveys a response to the second overhead message to an access network without waiting for another overhead message. By allowing the MS to attempt to access the network without waiting for, and decoding, another overhead message, repaging is avoided, system capacity and MS battery life is preserved, and communication session set up delay is reduced.

In order to minimize a likelihood that MS 102 improperly attempts to access the network, communication system 100 further provides for an expedited access attempt when the number of MSs indicated in the first overhead message is less than a threshold, thereby better assuring that MS 102 correctly determines that it is a target of the first overhead message and increasing the likelihood that access network 140 intends to page the MS despite an unsuccessful decoding of the second overhead message. Communication system 100 further provides, in determining whether MS 102 may attempt an access of access network 140 despite unsuccessfully decoding the second overhead message, for consideration of one or more of a power level of a power source of the MS, a quantity of time remaining until the MS is likely to otherwise convey a message to the access network, a possibility that another MS may attempt to contact MS 102, a knowledge that a data update or a collection of data is available for conveyance to the access network, a quantity of previous quick page messages that comprised an indicator that matched an indicator associated with the MS, and a paging interval, such as a quick page or a paging message interval, known to the MS.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. The terms “including” and/or “having,” as used herein, are defined as comprising. The term “coupled,” as used herein, is defined as connected, although not necessarily directly, and not necessarily mechanically. An element preceded by “ . . . a” does not, without more constraints, preclude the existence of additional identical elements in the process, method, article, or apparatus that the element. Furthermore, unless otherwise indicated herein, the use of relational terms, if any, such as first and second, top and bottom, and the like are used solely to distinguish one entity or action from another entity or action without necessarily requiring or implying any actual such relationship or order between such entities or actions.

What is claimed is:

1. A method for exchanging signaling in a wireless communication system comprising:
decoding, by a mobile station, a first overhead message comprising one or more indicators, wherein each indicator of the one or more indicators is associated with a mobile station being paged;
determining, based on the one or more indicators, whether the mobile station is an intended target of the first overhead message;
in response to determining that the mobile station is an intended target of the first overhead message, attempting to decode a second overhead message comprising another one or more indicators associated with the mobile stations being paged; and
in response to unsuccessfully decoding the second overhead message, conveying a response to the second overhead message to an access network without waiting for a successful decoding of an additional overhead message.

2. The method of claim 1, wherein the first overhead message is a quick page message and each of the second overhead message and the additional overhead message is a paging message.

3. The method of claim 1, wherein each indicator included in the first overhead message comprises a portion, but less than all, of a mobile station identifier.

4. The method of claim 1, wherein determining, based on the one or more indicators, whether the mobile station is an intended target of the first overhead message comprises executing an equation to determine whether the mobile station is an intended target of the first overhead message.

5. The method of claim 1, wherein each indicator included in the second overhead message comprises a complete mobile station identifier.

6. The method of claim 1, wherein each indicator included in the second overhead message comprises a portion of the mobile station identifier.

7. The method of claim 1, wherein conveying a response to the second overhead message comprises attempting to access the access network without waiting for an additional overhead message.

8. The method of claim 1, wherein the second overhead message is a paging message and wherein conveying a response to the second overhead message comprises conveying a page response to the access network without waiting for another paging message.

9. The method of claim 1, wherein conveying a response to the second overhead message to an access network without waiting for an additional overhead message comprises determining whether to convey a response to the second overhead message based on a quantity of indicators in the first overhead message.

10. The method of claim 9, wherein conveying a response to the second overhead message to an access network without waiting for an additional overhead message comprises conveying a response to the second overhead message when the quantity of indicators in the first overhead message is less than a threshold.

11. The method of claim 9, wherein conveying a response to the second overhead message to an access network without waiting for an additional overhead message comprises conveying a response to the second overhead message when the quantity of indicators in the first overhead message is within a given range of quantities.

12. The method of claim 1, wherein conveying a response to the second overhead message to an access network without waiting for an additional overhead message comprises determining whether to convey a response to the second overhead message based on one or more of:
a battery level of the mobile station,
whether the mobile station is plugged in,
a time period remaining until a next presence update,
a time period remaining until an email synchronization,
knowledge that a presence attribute associated with a presentity associated with the mobile station has changed but that the change has not yet been conveyed to the access network,
a state of a presence attribute associated with a presentity associated with the mobile station,
a state of a presence attribute associated with a presentity associated with a user of a buddy mobile station,
a presence of one or more emails in an outbox of the mobile station that have not yet been conveyed to the access network,
a quantity of emails in an outbox of the mobile station that have not yet been conveyed to the access network,
a distance to a next routing area, and
a time until a next routing area update.

13. The method of claim 1, wherein the first overhead message is a quick page message and wherein conveying a response to the second overhead message to an access network without waiting for an additional overhead message comprises determining whether to convey a response to the second overhead message based on a quantity of previous quick page messages that comprised an indicator that matched an indicator associated with the decoding mobile station.

14. The method of claim 1, wherein conveying a response to the second overhead message to an access network without waiting for an additional overhead message comprises determining whether to convey a response to the second overhead message based on a paging interval associated with the decoding mobile station.

15. A mobile station that is configured to respond to signaling in a wireless communication system by decoding a first overhead message comprising one or more indicators, wherein each indicator of the one or more indicators is associated with a mobile station being paged, determining, based on the one or more indicators, whether the mobile station is an intended target of the first overhead message, in response to determining that the mobile station is an intended target of the first overhead message, attempting to decode a second overhead message comprising another one or more indicators associated with the mobile stations being paged, and in response to unsuccessfully decoding the second overhead message, conveying a response to the second overhead message to an access network without waiting for a successful decoding of an additional overhead message.

16. The mobile station of claim 15, wherein the first overhead message is a quick page message and each of the second overhead message and the additional overhead message is a paging message.

17. The mobile station of claim 15, wherein each indicator included in the first overhead message comprises a portion, but less than all, of a mobile station identifier.

18. The mobile station of claim 15, wherein the mobile station is configured to determine, based on the one or more indicators, whether the mobile station is an intended target of the first overhead message by executing an equation.

19. The mobile station of claim 15, wherein each indicator included in the second overhead message comprises a complete mobile station identifier.

20. The mobile station of claim 15, wherein each indicator included in the second overhead message comprises a portion of a mobile station identifier.

21. The mobile station of claim 15, wherein the mobile station is configured to convey a response to the second overhead message by attempting to access the access network without waiting for an additional overhead message.

22. The mobile station of claim 15, wherein the second overhead message is a paging message and wherein the mobile station is configured to convey a response to the second overhead message by conveying a page response to the access network without waiting for another paging message.

23. The mobile station of claim 15, wherein the mobile station is configured to convey a response to the second overhead message to an access network without waiting for an additional overhead message by determining whether to convey a response to the second overhead message based on a quantity of indicators in the first overhead message.

24. The mobile station of claim 23, wherein the mobile station is configured to convey a response to the second overhead message to an access network without waiting for an additional overhead message by conveying a response to the second overhead message when the quantity of indicators in the first overhead message is less than a threshold.

25. The mobile station of claim 23, wherein the mobile station is configured to convey a response to the second overhead message to an access network without waiting for an additional overhead message by conveying a response to the second overhead message when the quantity of indicators in the first overhead message is within a given range of quantities.

26. The mobile station of claim 15, wherein the mobile station is configured to convey a response to the second overhead message to an access network without waiting for an additional overhead message by determining whether to convey a response to the second overhead message based on one or more of:
a battery level of the mobile station,
whether the mobile station is plugged in,
a time period remaining until a next presence update,
a time period remaining until an email synchronization,
knowledge that a presence attribute associated with a presentity associated with the mobile station has changed but that the change has not yet been conveyed to the access network,
a state of a presence attribute associated with a presentity associated with the mobile station,
a state of a presence attribute associated with a presentity associated with a user of a buddy mobile station,
a presence of one or more emails in an outbox of the mobile station that have not yet been conveyed to the access network,
a quantity of emails in an outbox of the mobile station that have not yet been conveyed to the access network,
a distance to a next routing area, and
a time until a next routing area update.

27. The mobile station of claim 15, wherein the first overhead message is a quick page message and wherein the mobile station is configured to convey a response to the second overhead message to an access network without waiting for an additional overhead message by determining whether to convey a response to the second overhead message based on a quantity of previous quick page messages that comprised an indicator that matched an indicator associated with the decoding mobile station.

28. The mobile station of claim 15, wherein the mobile station is configured to convey a response to the second overhead message to an access network without waiting for an additional overhead message by determining whether to convey a response to the second overhead message based on a paging interval associated with the decoding mobile station.
